(19) United States
(12) Patent Application Publication
(10) Pub. No.: US 2016/0321687 A1
(43) Pub. Date: Nov. 3, 2016

(54) SYSTEMS AND METHODS FOR DYNAMIC PRICE DELIVERY

(71) Applicant: MASTERCARD INTERNATIONAL INCORPORATED, Purchase, NY (US)

(72) Inventor: Justin X. Howe, San Francisco, CA (US)

(73) Assignee: MASTERCARD INTERNATIONAL INCORPORATED, Purchase, NY (US)

(21) Appl. No.: 14/700,979

(22) Filed: Apr. 30, 2015

(51) Int. Cl. G06Q 30/02; H04N 21/2543; H04N 21/258; G06Q 30/06

(52) U.S. Cl. CPC G06Q 30/0206; G06Q 30/0611; H04N 21/25435; H04N 21/25883; H04N 21/25891

(57) ABSTRACT

Systems and methods of determining a dynamic price of a media content item and delivering the dynamic price of the media content item to a user are disclosed. Cardholder data may be provided by the user and may be associated with payment account data. Data associated with media content item(s) may be acquired. Dynamic price(s) for individual media content item(s) may be determined based on the payment account data, the data associated with the media content and a number of viewers. The dynamic price(s) may be displayed and a media content item selected. After receiving an authorization for a dynamic price for the selected media content item, streaming of the selected media content item may be enabled.

### FIELD OF TECHNOLOGY

The present disclosure relates generally to processing and developing data for determining pricing for media content.

### BACKGROUND

Media content items may be available to consumers via multiple delivery systems available at various times. For example, a movie may be available to watch via a cinema on a first date, to rent while an airline passenger on a second date, to rent via a physical store or virtual marketplace on a third date, to purchase via a physical store or virtual marketplace on a fourth date and to stream via a physical or online media content subscription on a fifth date. Presently, pricing of the movie is strongly correlated to a length of delay from a release date to when the movie is available on each delivery system. For example, a movie costs more to watch at the cinema than when renting the movie via the physical store or virtual marketplace, but there may be a delay of several months between the release date and the date the movie is available for rental. Thus, pricing is strongly correlated to delivery systems or distribution channels and a length of delay is used to command a higher price.

However, due to the cycling of media content through each of the delivery systems, media content items may not be conveniently available to view, purchase or rent or may not even be available for consumers to view, rent or purchase for a period of time at any price. Thus, some consumers consume copyright infringing content, such as pirated copies of the media content items, despite being willing to pay to legally view, rent or purchase the media content item. Similarly, some consumers avoid the media content until it becomes available on a more convenient delivery system not due to price, but due to convenience.

### SUMMARY

A dynamic price delivery system may include a data warehouse, a server, a dynamic price delivery device and/or a media purchase database connected via network(s). The dynamic price delivery device may transmit payment account data to the server and may receive dynamic price(s) for media content item(s). The dynamic price delivery device may display the dynamic price(s) for the media content item(s) to a user and may receive confirmation of the user's acceptance of a dynamic price for a selected media content item. After confirmation of the user's acceptance of the dynamic price, the dynamic price delivery device may enable streaming of the selected media content item to the display.

### BRIEF DESCRIPTION OF THE DRAWINGS

The features, nature, and advantages of the present disclosure will become more apparent from the detailed description set forth below when taken in conjunction with the drawings in which like reference characters identify corresponding aspects throughout.

FIG. 1 is a network diagram illustrating a dynamic price delivery system according to aspects of the present disclosure.

FIG. 2 is a block diagram illustrating a credit card transaction system according to aspects of the present disclosure.

FIG. 3 is a block diagram illustrating a process flow for delivering dynamic price(s) according to aspects of the present disclosure.

FIG. 4 is a block diagram illustrating a method for generating dynamic price(s) according to aspects of the present disclosure.

FIG. 5A-5B are block diagrams illustrating examples of a method for delivering dynamic price(s) according to aspects of the present disclosure.

FIGS. 6A-6B are block diagrams illustrating components of a system including one or more of an electronic device and a server.

### DETAILED DESCRIPTION OF EMBODIMENTS

The present disclosure provides a system and method for determining a dynamic price for a media content item and providing the dynamic price to consumers. Using the specially configured system and method according to the disclosure, a media content item may be offered directly to consumers via a virtual marketplace as soon as the media content item is released. In exchange for the convenience of viewing the media content item immediately, media revenue is enhanced as the consumer may be charged a higher dynamic price to rent/use the media content item than a typical price available after a delay of several months.

The terminology used herein is for the purpose of describing particular embodiments only and is not intended to be limiting of the present disclosure. As used herein, the term “media content” may collectively or individually refer to video content, audio content, video game content, written media like books, newspapers or magazines, and/or any other multimedia content. Examples of video content may include documentaries, video clips, movies, television shows and/or any other video content, while examples of audio content may include music, audiobooks, lectures and/or any other audio content. Media content consumption may include purchasing the media content, viewing the media content, listening to the media content, playing the media content or accessing the media content. For example, media content consumption may occur when a consumer purchases or rents media content and/or accesses the media content using a subscription based service.

The terms “card” and “payment card” may be used interchangeably herein to describe a card that can be presented by the cardholder to make a payment for a media content item or that can be used to make a payment in a remote transaction, such as an e-commerce transaction, telephone transaction, or mail order for example. The remote transactions such as e-commerce transactions, telephone transactions and mail order transactions, in which the card is not presented directly to a merchant during the transaction, are referred to herein as card-not-present (“CNP”) transactions.

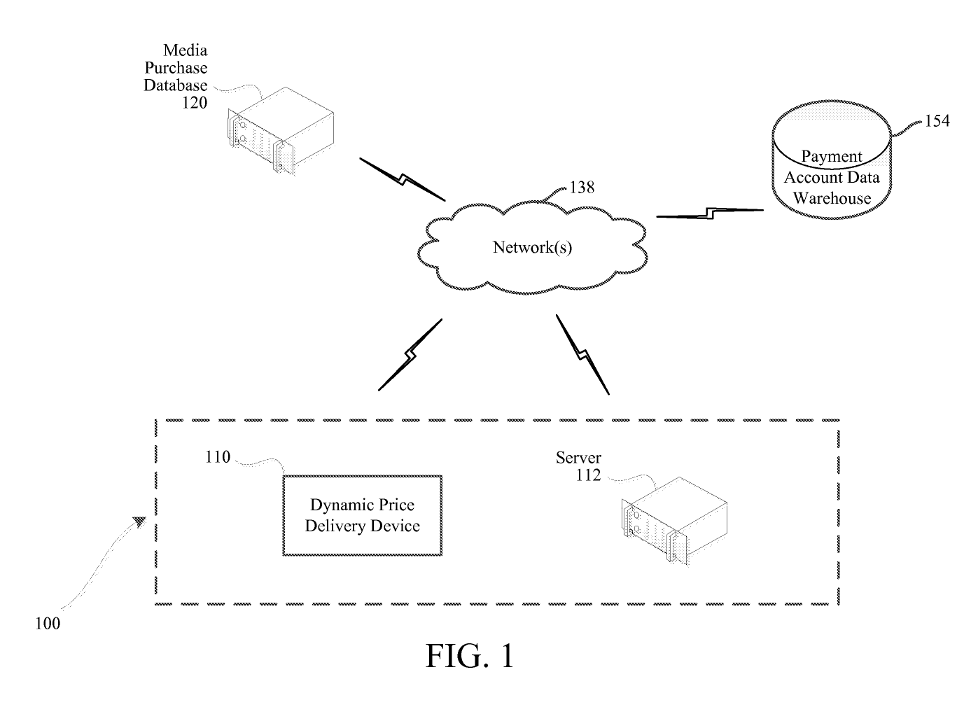

FIG. 1 is a network diagram illustrating a dynamic price delivery system 100 according to aspects of the present disclosure. As illustrated in FIG. 1, the dynamic price delivery system 100 may include a data warehouse 154, a server 112, a dynamic price delivery device 110 and/or a media purchase database 120 connected via network(s) 138.

The data warehouse 154 may store payment account data for individual account(s). For example, the payment account data may include transaction data associated with individual account number(s), the transaction data including a transaction amount, location, product or service types, etc. for one or more transactions. The individual account(s) may include one or more accounts associated with an individual or a household. For example, an individual may have two accounts and a spouse of the individual may have a third account. These three accounts may have unique account numbers and may be stored as separate accounts. Alternatively, these three accounts may be grouped together as a household account and either have unique account numbers or a combined account number. The dynamic price delivery system 100 may access the payment account data provided by the data warehouse 154 and may use the payment account data to calculate a dynamic price for media content item(s).

The media purchase database 120 may include a list of media content item(s), viewed or otherwise purchased, associated with corresponding account number(s). The media purchase database 120 may be included in the data warehouse 154, the server 112 or may be a distinct device connected to the server 112 via the network(s) 138.

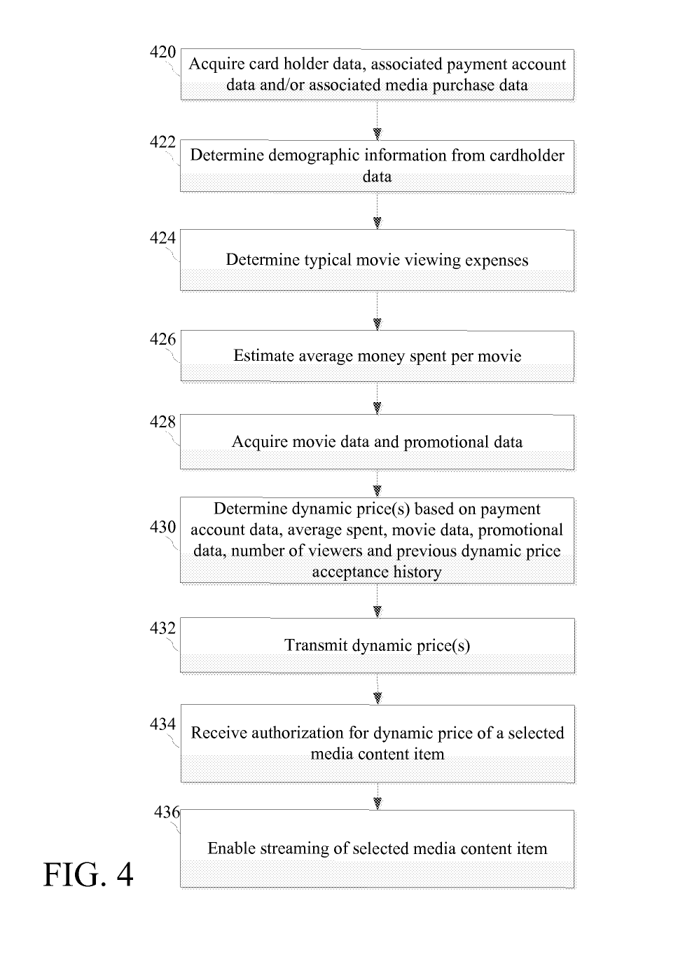

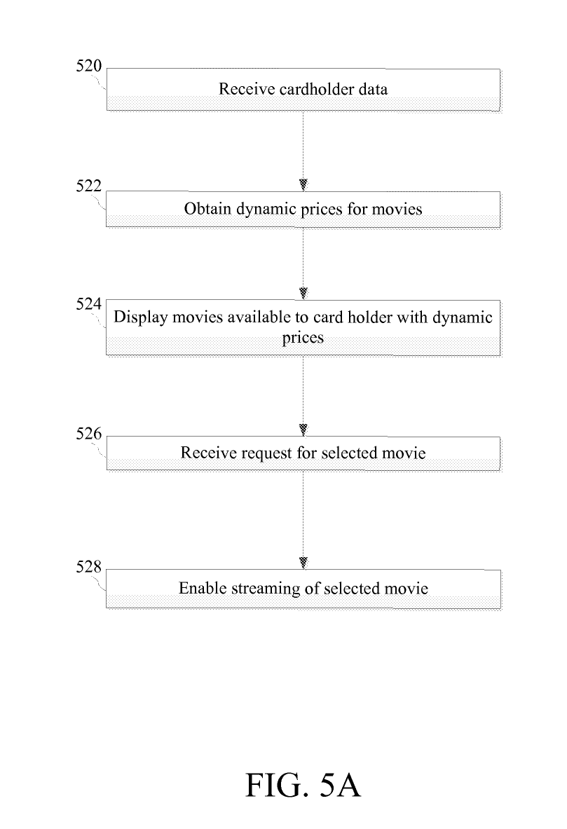

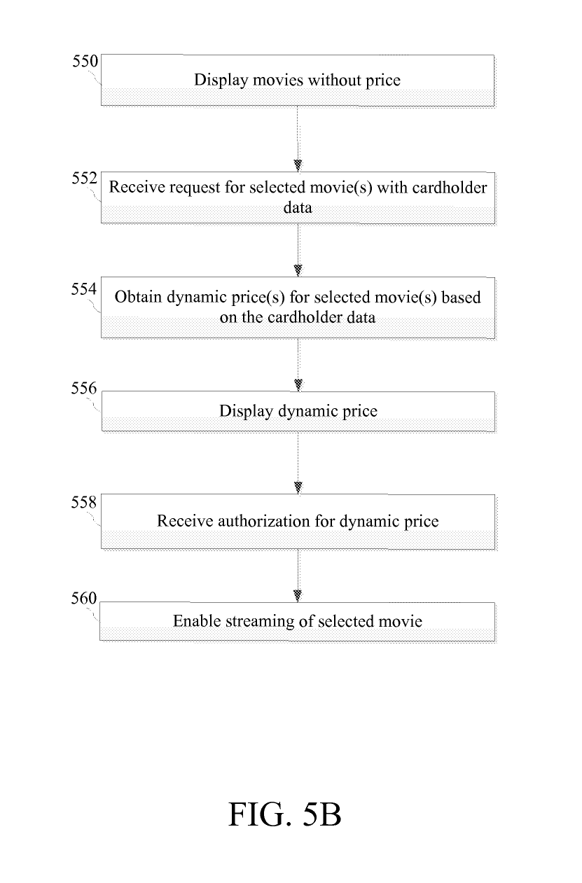

The server 112 may access the payment account data provided by the data warehouse 154. The server 112 may access the media purchase database 120 and obtain the media content item(s) associated with an account number. The server 112 may access public or private movie data and/or promotional data via network(s) 138. The number of viewers of a media content item may be inferred from a purchase price paid at a venue, such as a movie theater. The server 112 may use the payment account data, the media content item(s), the movie data and/or the promotional data to calculate dynamic price(s) for media content item(s). For example, the dynamic price may be based on movie data (such as a release date and/or an average ticket price), promotional data (such as promotions that lower the price to increase purchases), number of viewers and/or prior media purchase data from the payment account data (such as an average amount spent on movies and/or previous dynamic price history). The method for calculating the dynamic price is described in greater detail below with regard to FIGS. 4, 5A and 5B.

The dynamic price delivery device 110 may be connected to a display or terminal, such as a television, and may stream media content item(s) from the network(s) 138 to the display. However, the disclosure is not limited thereto and the dynamic price delivery device 110 may be connected to a streaming device (not shown) configured to stream media content item(s) from the network(s) 138 to the display. In either configuration, the dynamic price delivery device 210 may transmit payment account data to the server 112 and may receive dynamic price(s) for media content item(s). The dynamic price delivery device 110 may display the dynamic price(s) for the media content item(s) to a user and may receive confirmation of the user's acceptance of a dynamic price for a selected media content item. After confirmation of the user's acceptance of the dynamic price, the dynamic price delivery device 110 may enable streaming of the selected media content item to the display.

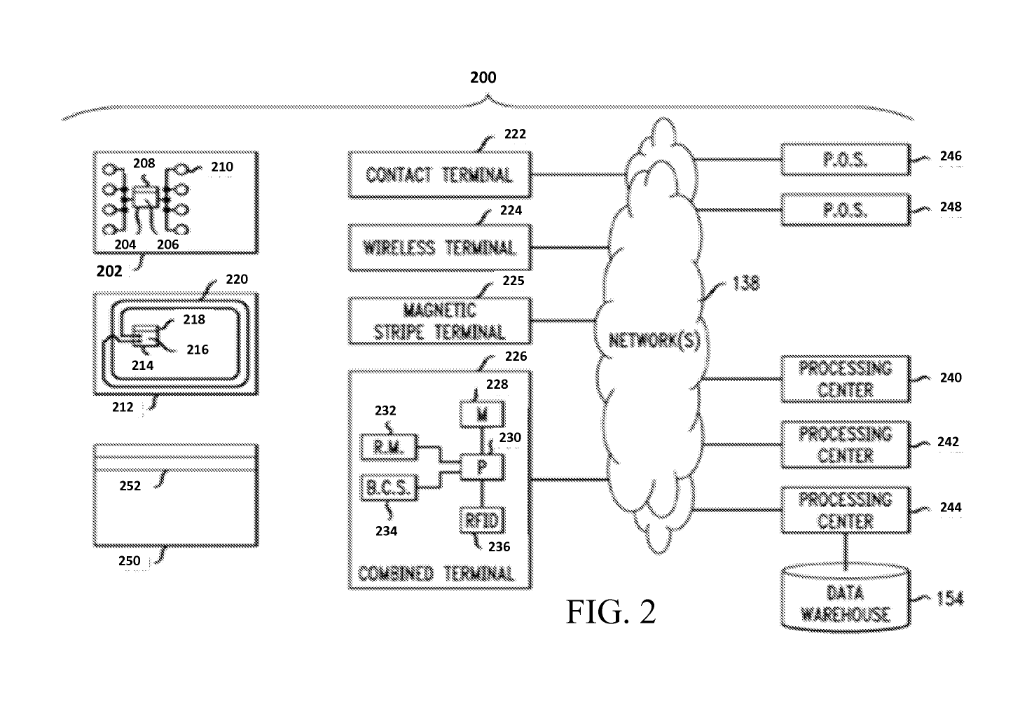

FIG. 2 depicts a system 200 including various possible components for implementing dynamic price delivery and media revenue enhancements according to aspects of the present disclosure. Payments for media purchases would generally be made by credit card or other payment device. It should be noted that for completeness and generality, presentation of certain physical cards such as known credit or debit cards to certain terminals will be described. However, aspects of the present disclosure involve credit accounts and transaction data that is not dependent on a physical card or terminal, for example. In FIG. 2, the system 200 includes a contact device such as card 202. Card 202 can include an integrated circuit (IC) chip 204 having a processor portion 206 and a memory portion 208. A plurality of electrical contacts 210 can be provided for communication purposes. In addition to or instead of card 202, system 200 can also be designed to work with a contactless device such as card 212. Card 212 can include an IC chip 214 having a processor portion 116 and a memory portion 218. An antenna 220 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 202, 212 are examples of a variety of devices that can be employed for communicating transaction data according to aspects of the present disclosure. Other types of devices used in lieu of or in addition to “smart” or “chip” cards 202, 212 could include a conventional card 250 having a magnetic stripe 252, an appropriately configured cellular telephone handset (not shown), or the like. Indeed, techniques can be adapted to a variety of different types of cards, terminals, and other devices, generally referred to as “payment devices,” configured, for example, according to a payment system standard (and/or specification).

The ICs 204, 214 can contain processing units 206, 216 and memory units 208, 218. Preferably, the ICs 204, 214 can also include one or more of control logic, a timer, and input/output ports. Such elements are well known in the IC art and are not separately illustrated. One or both of the ICs 204, 214 can also include a co-processor, again, well-known and not separately illustrated. The control logic can provide, in conjunction with processing units 206, 216, the control necessary to handle communications between memory unit 208, 218 and the input/output ports. The timer can provide a timing reference signal from processing units 206, 216 and the control logic. The co-processor could provide the ability to perform complex computations in real time, such as those required by cryptographic algorithms.

The memory portions or units 208, 218 may include different types of memory, such as volatile and non-volatile memory and read-only and programmable memory. The memory units can store protected transaction card data such as, e.g., a user's primary account number (“PAN”) and/or personal identification number (“PIN”). The memory portions or units 208, 218 can store the operating system of the cards 202, 212. The operating system loads and executes applications and provides file management or other basic card services to the applications. One operating system that can be used is the MULTOS® operating system licensed by MAOSCO Limited (MAOSCO Limited, St. Andrews House, The Links, Kelvin Close, Birchwood, Warrington, Wash.3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. The operating system may be stored in read-only memory (“ROM”) within memory portion 208, 218. In an alternate embodiment, flash memory or other non-volatile and/or volatile types of memory may also be used in the memory units 208, 218.

As noted, cards 202, 212 are examples of a variety of payment devices that can be employed. The primary function of the payment devices may not be payment, for example, they may be cellular phone handsets. Such devices could include cards having a conventional form factor, smaller or larger cards, cards of different shape, key fobs, personal digital assistants (PDAs) or tablets, appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 208, 218 associated with the body portions, and processors 206, 216 associated with the body portions and coupled to the memories. The memories 208, 218 can contain appropriate applications. The processors 206, 216 can be operative to implement appropriate functionality including some or all of the functionality described to implement dynamic price delivery. The applications can be, for example, application identifiers (AIDs) linked to software code in the form of firmware plus data in a card memory such as an electrically erasable programmable read-only memory (EEPROM).

A number of different types of terminals can be employed with system 200. Such terminals can include a contact terminal 222 configured to interface with contact-type device 202, a wireless terminal 224 configured to interface with wireless device 212, a magnetic stripe terminal 225 configured to interface with a magnetic stripe device 250, or a combined terminal 226. Combined terminal 226 is designed to interface with any type of device 202, 212, 250. Some terminals can be contact terminals with plug-in contactless readers. Combined terminal 226 can include a memory 228, a processor portion 230, a reader module 232, and optionally an item interface module such as a bar code scanner 234 and/or a radio frequency identification (RFID) tag reader 236. Items 228, 232, 234, 236 can be coupled to the processor 230. Note that the principles of construction of terminal 226 are applicable to other types of terminals and are described in detail for illustrative purposes. Reader module 232 can be configured for contact communication with card or device 202, contactless communication with card or device 212, reading of magnetic stripe 252, or a combination of any two or more of the foregoing (different types of readers can be provided to interact with different types of cards e.g., contacted, magnetic stripe, or contactless). Terminals 222, 224, 225, 226 can be connected to one or more processing centers 240, 242, 244 via a computer network(s) 138.

Network(s) 138 could include, for example, the Internet, or a proprietary network (for example, a virtual private network, such as the BANKNET® virtual private network (VPN) of MasterCard International Incorporated of Purchase, N.Y., USA). More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 240, 242, 244 can include, for example, a host computer of an issuer of a payment device (or processing functionality of other entities discussed in other figures herein). Issuers can include issuers for cardless credit card accounts as well.

Many different retail or other establishments, as well as other entities, generally represented by points-of-sale 246, 248, can be connected to network(s) 138. Different types of portable payment devices, terminals, or other elements or components can combine or “mix and match” one or more features depicted on the exemplary devices in FIG. 2.

Portable payment devices can facilitate transactions by a user with a terminal, such as 222, 224, 225, 226, of a system such as system 200. Such a device can include a processor, for example, the processing units 206, 216 discussed above. The device can also include a memory, such as memory portions 208, 218 discussed above, that is coupled to the processor. Further, the device can include a communications module that is coupled to the processor and configured to interface with a terminal such as one of the terminals 222, 224, 225, 226. The communications module can include, for example, the contacts 210 or antennas 220 together with appropriate circuitry (such as the aforementioned oscillator or oscillators and related circuitry) that permits interfacing with the terminals via contact or wireless communication. The processor of the apparatus can be operable to implement appropriate functionality. The processor can perform such operations via hardware techniques, and/or under the influence of program instructions, such as an application, stored in one of the memory units.

It will be appreciated that the terminals 222, 224, 225, 226 are examples of terminal apparatuses for interacting with a payment device of a holder. The apparatus can include a processor such as processor 130, a memory such as memory 228 that is coupled to the processor 230, and a communications module 232 that is coupled to the processor 230 and configured to interface with the portable apparatuses 202, 212, 242. The processor 230 can be operable to communicate with portable payment devices of a user via the communications module 232. The terminal apparatuses can function via hardware techniques in processor 230, or by program instructions stored in memory 228. Such logic could optionally be provided from a central location such as processing center 240 over network(s) 138. The aforementioned bar code scanner 234 and/or RFID tag reader 236 can optionally be provided, and can be coupled to the processor, to gather attribute data, such as a product identification, from a UPC code or RFID tag on a product to be purchased.

The above-described devices 202, 212 can be ISO 7816-compliant contact cards or devices or NFC (Near Field Communications) or ISO 14443-compliant proximity cards or devices, for example. In operation, card 212 can be touched or tapped on the terminal 224 or 228, which then transmits the electronic data to the proximity IC chip in the card 212 or other wireless device. Magnetic stripe cards can be swiped in a well-known manner. In some instances, the card number is simply provided via web site, in a card-not present transaction or the like.

One or more of the processing centers 240, 242, 244 can include a database such as a data warehouse 154; for example, to hold transaction data as described below. It should be understood by persons skilled in the relevant arts that a database or data warehouse 154 may be directly linked to the one or more processing centers 240, 242, 244 or may be linked to the processing centers via the network(s) 138, for example.

In the context of card-not-present Internet transactions, the card or other device is not presented to terminal 222, 224, 225, or 226. Rather, appropriate account information (e.g., primary account number (PAN), cardholder name, cardholder address, expiration date, and/or security code, and so on) is provided to a merchant by a consumer using a web site or the like. The merchant then uses this information to initiate the authorization process.

The transaction data in the data warehouse 154 may include different categories, such as consumer credit card transaction data, consumer debit card transaction data and commercial credit card transaction data, for example. The transaction data may include data descriptive of transactions in various different countries and/or regions, for example. The transaction data may indicate transaction amounts, location, product or service types, a transaction product segment or categories, and numerous other transaction classifications, for example.

Because a large amount of financial services (e.g. credit card and payment processing) data may at times be subject to various strict privacy policies, regulations or statutes governing the storage and communication of such information, aspects of the present disclosure include systems that may not be configured in a standard technical environment using only standard communication techniques, conventional general purpose computer networks and communication equipment, for example. Rather, aspects of the present disclosure, such as may be implemented in such a special purpose network and computing environment as described, may provide substantial improvements to the conventional technical environments for accessing, storing and/or communicating credit card or payment processing information that include special purpose computer hardware, software, algorithms and/or communication techniques to secure and/or de-identify data and/or to ensure that data is accessed, communicated and stored in a manner that maintains its security and privacy. For example, the system may include special purpose computer hardware, software, algorithms and/or communication techniques or portions thereof that may be implemented by only a small number of industry stakeholders such as credit card issuers or payment processors, as may be able to properly process payment and pricing information such as disclosed, to for example ensure data privacy.

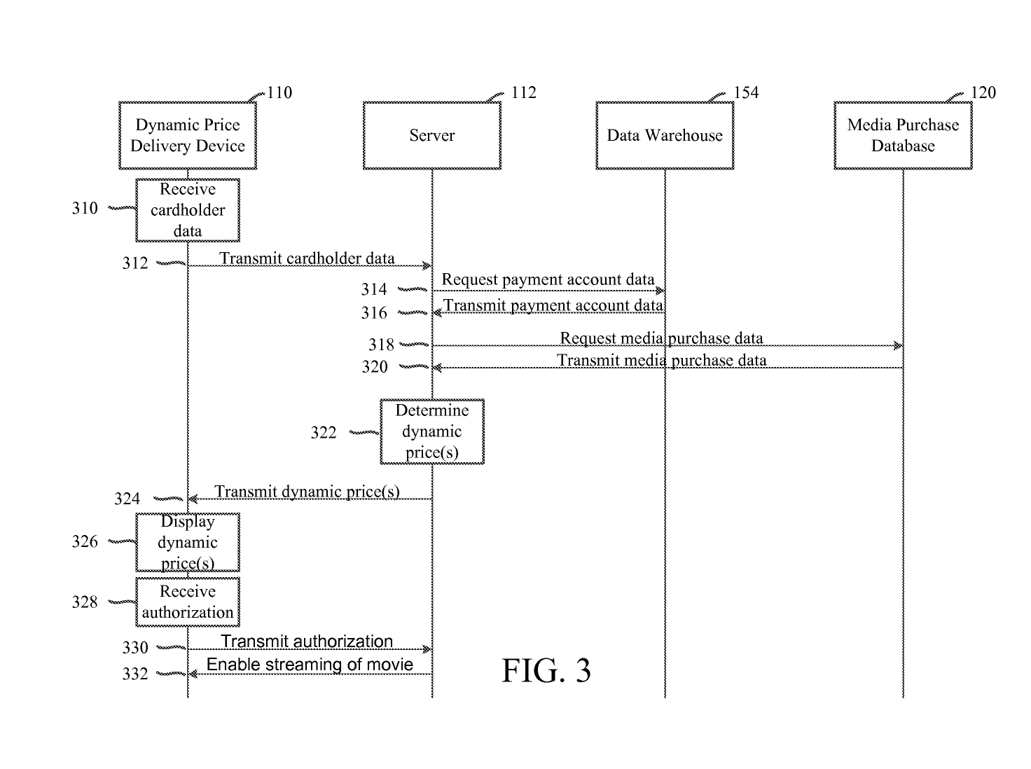

FIG. 3 is a block diagram illustrating a process flow for delivering dynamic price(s) according to aspects of the present disclosure. FIG. 3 illustrates various steps performed by and communication between the dynamic price delivery device 110, the server 112, the data warehouse 154 and the media purchase database 120. FIG. 3 is provided as an example and the disclosure is not limited thereto; additional steps and/or communication may be performed without departing from the disclosure.

The dynamic price delivery device 110 may receive (310) cardholder data and may transmit (312) the cardholder data to the server 112. The server may associate the cardholder data with an account and/or account number(s) and may request (314) payment account data associated with the account and/or account number(s) from the data warehouse 154. The data warehouse 154 may transmit (316) the payment account data to the server 112. The server 112 may request (318) media purchase data associated with the account and/or account number(s) from the media purchase database 120. The media purchase database 120 may transmit (320) media purchase data to the server 112. Based on the payment account data and the media purchase data, and described in greater detail below with regard to FIG. 4, the server 112 may determine (322) dynamic price(s) for movie(s). The server 112 may transmit (324) the dynamic price(s) to the dynamic price delivery device 110. The dynamic price delivery device 110 may display (326) the dynamic price(s) along with corresponding movie(s). The dynamic price delivery device 110 may receive (328) authorization for a dynamic price associated with a selected movie and may transmit (330) the authorization of the dynamic price to the server 112. The server 112 may then enable (332) streaming of the selected movie to the dynamic price delivery device 110.

While FIG. 3 illustrates the dynamic price delivery system 110 and the server 112 as separate devices, the functions of the dynamic price delivery system 110 and the server 112 may be combined in a single device without departing from the disclosure. In addition, while FIG. 3 illustrates the dynamic price delivery system 110 transmitting the authorization to the server 112 and the server 112 enabling streaming of the selected movie, the dynamic price delivery system 110 may transmit the authorization to a remote video streaming device (not shown) and the video streaming device may stream the movie to the dynamic price delivery system 110 without involving the server 112 in the authorization process.

FIG. 4 is a block diagram illustrating a method for generating dynamic price(s) according to aspects of the present disclosure. The implementation of dynamic price determination is generally commenced upon a customer seeking to access media content such as on an airline this may commenced upon the customer swiping a credit card, or for example in accessing online content (for example on Amazon.com or iTunes) by the a user having card information accessed via their user profile. The dynamic price delivery system 100 may acquire (420) cardholder data, associated payment account data and/or associated media purchase data. For example, a user may input the cardholder data or payment account data in response to a request by the dynamic price delivery system 100. The dynamic price delivery system 100 may retrieve payment account data from the data warehouse 154, the payment account data including one or more transactions associated with one or more account numbers within a period of time. In addition, the dynamic price delivery system 100 may retrieve a list of media content item(s) associated with the one or more account numbers from the media purchase database 120.

The dynamic price delivery system 100 may determine (422) demographic information from the cardholder data. For example, the dynamic price delivery system 100 may determine a number of demographic members and age(s) of demographic member(s) based on the payment account data associated with the cardholder data. The dynamic price delivery system 100 may determine (424) typical movie viewing expenses based on previous transactions included in the payment account data. The dynamic price delivery system 100 may estimate (426) an average money spent per movie or an average amount per person. For example, first typical movie viewing expenses may include higher priced options, such as frequent movie theater purchases. In contrast, second typical movie viewing expenses may include lower priced options, such as waiting for movies to be available for free via online subscriptions. The average money spent on movies using the first typical movie viewing expenses is higher than the average money spent on movies using the second typical movie viewing expenses.

The dynamic price delivery system 100 may acquire (428) movie data and promotional data. To acquire movie data, the dynamic price delivery system 100 may access publicly available information, such as websites listing movie showtimes, movie ratings and how long movie(s) have been released. The dynamic price delivery system 100 may receive the promotional data via the network(s) 138.

The dynamic price delivery system 100 may determine (430) dynamic price(s) based on the payment account data, the list of media content items associated with the payment account data, an average money spent per movie, movie data, promotional data, a number of viewers and/or previous dynamic price acceptance history. The dynamic price delivery system 100 may utilize the cardholder data, associated payment account data and/or associated media purchase data to dynamically determine individual prices based on the particular account associated with the cardholder data. Due to the complexity involved, including manipulating potentially hundreds of datapoints in four or more separate databases (for example, payment account data warehouse 154, media purchase database 120, movie data database (not shown), promotional data database (not shown) and/or additional databases) to determine each dynamic price, the dynamic price delivery system 100 requires a processor that plays a significant part in permitting the dynamic price to be determined. For example, the use of the processor allows the dynamic price delivery system 100 to determine variable dynamic price(s) based on progressively updated information individualized to each account, integrating several concepts into a new and novel system for pricing a movie that has not previously been attempted.

While the number of viewers may be determined based on the demographic information as illustrated in step 422, the number of viewers may also be determined based on the typical movie viewing expenses or based on a self-reported amount. For example, the demographic information may list a family of 5, but the typical movie viewing expenses may show that only 3 family members typically attend the movies. In addition, if prompted to input the number of viewers the user may input an exact amount viewing the movie that may be less than a number of family members or may exceed the number of family members. Thus, as the number of viewers may change depending on the situation, it may be beneficial to request the number of viewers from the user instead of inferring based on payment account data.

If previous dynamic price acceptance history exists, this history may be used in calculating the dynamic price(s). For example, the dynamic price delivery system 100 may increase (to increase profitability based on a likelihood the user will pay) or decrease (to reward the user for accepting prior dynamic prices) the dynamic price(s) offered if the dynamic price acceptance history includes several accepted dynamic prices. Similarly, the dynamic price delivery system 100 may decrease the dynamic price(s) offered to encourage user acceptance if the dynamic price acceptance history does not include accepted dynamic prices.

The dynamic price delivery system 100 may transmit (432) the dynamic price(s). If a movie is selected and the associated dynamic price is authorized by a user, the dynamic price delivery system 100 may receive (434) authorization (i.e. the customer agreeing to the price) for the dynamic price associated with the selected movie. The dynamic price delivery system 100 may enable (436) streaming of the selected movie in response to the authorization for the dynamic price.

FIG. 5A-5B are block diagrams illustrating a method for delivering dynamic price(s) according to aspects of the present disclosure. FIG. 5A illustrates a general example of a method for delivering dynamic price(s) if cardholder data is obtained prior to browsing available movies. For example, the dynamic price delivery system 100 may calculate multiple dynamic prices and display the dynamic prices along with the movies. As an alternative, FIG. 5B illustrates a general example of a method for delivering dynamic price(s) if cardholder data is obtained subsequent to selecting movie(s). For example, the dynamic price delivery system 100 may receive the selected movie(s) and may calculate dynamic price(s) for the selected movie(s).

As illustrated in FIG. 5A, the dynamic price delivery system 100 may receive (520) cardholder data associated with payment account data. The cardholder data may be input by a user or may be associated with an account and may require authorization from a user to use the cardholder data. Authorization may be obtained by entering a personal identification number (PIN), select cardholder data, a password or any other authorization method known to one of skill in the art. The dynamic price delivery system 100 may obtain (522) dynamic prices for movies and may display (524) movies available to the cardholder along with the dynamic prices. The dynamic price delivery system 100 may receive (526) a request for a selected movie and may enable (528) streaming of the selected movie to the user.

As illustrated in FIG. 5B, the dynamic price delivery system 100 may display (550) movies available without a price. After the user selects movie(s), the dynamic price delivery system 100 may receive (552) a request for selected movie(s) along with cardholder data. The dynamic price delivery system 100 may obtain (554) dynamic price(s) for selected movie(s) based on the cardholder data and may display (556) dynamic price(s). The dynamic price(s) may be rejected or a movie may be selected and the corresponding dynamic price authorized. Authorization, that is acceptance of the dynamic price, may be obtained by entering a personal identification number (PIN), select cardholder data, a password or any other authorization method known to one of skill in the art. The dynamic price delivery system 100 may receive (558) authorization for the selected dynamic price and may enable (560) streaming of the selected movie.

As an example of authorization, a customary authorization flow may send a message from an acquirer to an issuer, and the issuer may send an authorization response to the acquirer. This authorization response may be modified to include a targeted price in a supplemental field when a given transaction is approved by the issuer. A cardholder's acceptance of the dynamic price would be captured by the merchant, made a pre-requisite to sending a clearing record for the transaction, or an additional authorization message could be required so that funds would not mistakenly be made unavailable to the cardholder. Alternatively, an acquirer may submit a ‘hold-release’ message for an account if the cardholder did not accept the dynamic price.

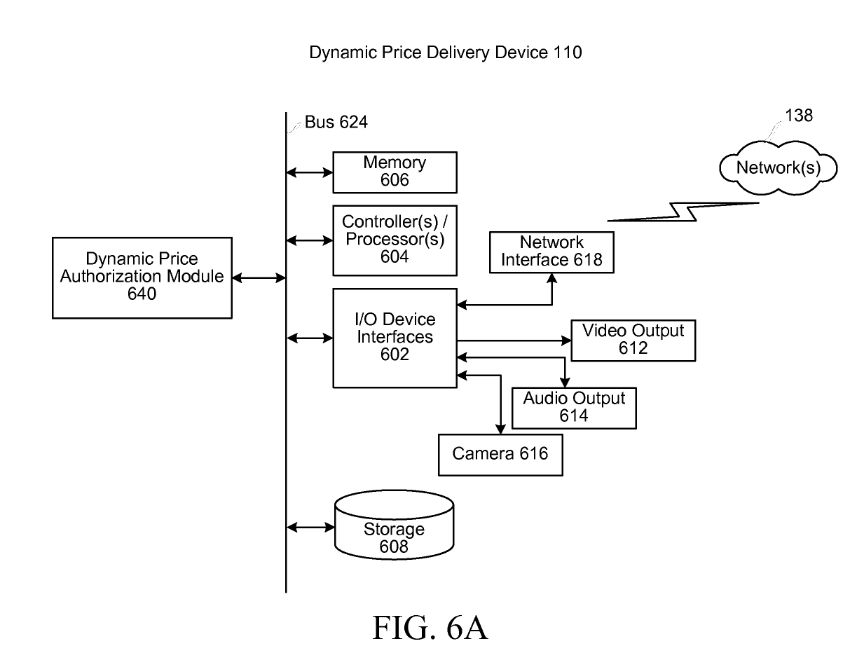

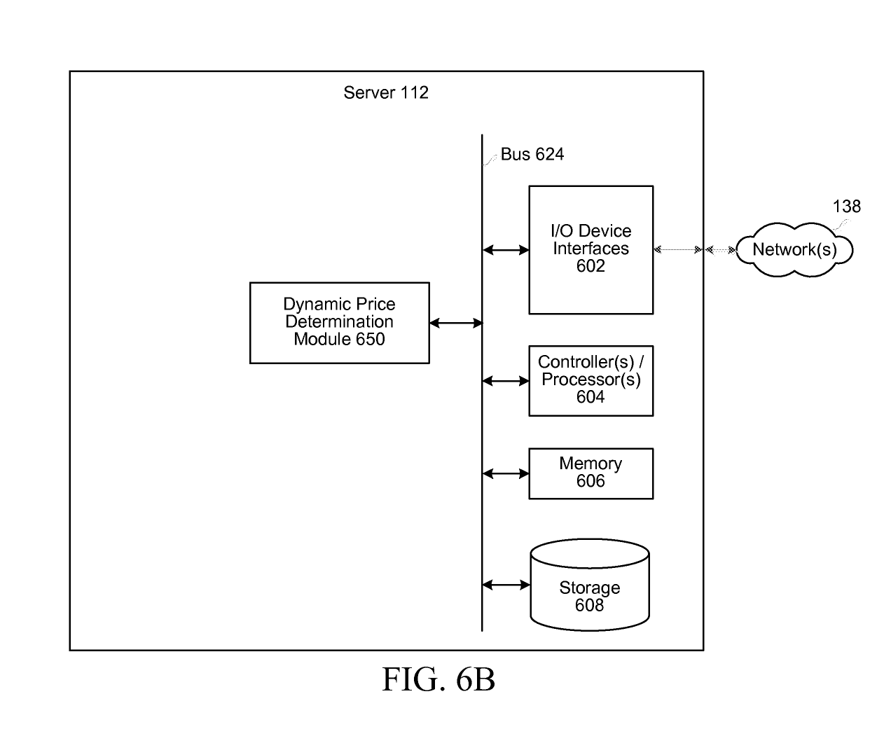

FIGS. 6A and 6B are block diagrams illustrating components of a system including one or more of an electronic dynamic price delivery device 110 and a server 112. Depending upon how the system is structured, some of the components illustrated in FIG. 6A as part of the device 110 or in FIG. 6B as part of the server 112 may be included only in the device 110 or in the server 112, or may be distributed across multiple devices 110 and/or servers 112. Other components not illustrated may also be included in the device 110 and/or the server 112. In operation, the system may include computer-readable and computer-executable instructions that reside in storage 608 on the device 110 and/or server 112. The device 110 may be a computer or a portable device, such as an electronic reader, a smart phone, tablet, or the like. The server 112 may be a single server or a group of servers. The teachings of the present disclosure may be applied within a number of specially configured different devices and computer systems.

The device 110 and/or server 112 may include one or more controllers/processors 604 comprising one-or-more central processing units (CPUs) for processing data and computer-readable instructions, and a memory 606 for storing data and instructions. The memory 606 may include volatile random access memory (RAM), non-volatile read only memory (ROM), non-volatile magnetoresistive (MRAM) and/or other types of memory. The device 110 and/or server 112 may also include a data storage component 608 for storing data and processor-executable instructions. The data storage component 608 may include one or more non-volatile storage types such as magnetic storage, optical storage, solid-state storage, etc. The device 110 and/or server 112 may also be connected to a removable or external non-volatile memory and/or storage (such as a removable memory card, memory key drive, networked storage, etc.) through the input/output device interfaces 602.

Executable instructions for operating the device 110 and/or server 112 and their various components may be executed by the controller(s)/processor(s) 604, using the memory 606 as temporary “working” storage at runtime. The executable instructions may be stored in a non-transitory manner in non-volatile memory 606, storage 608, or an external device. Alternatively, some or all of the executable instructions may be embedded in hardware or firmware in addition to or instead of software.

As shown in FIG. 6A, the device 110 may include one or more buttons (not shown) or other input components such as a keyboard (not shown). Several of each of these components may be included. The network interface 618 and related components (e.g., radio transmitter/receiver/transceiver, modem, Ethernet port, etc.) may be configured to operate with network(s) 138, for example the Internet, a proprietary network (for example, a virtual private network, such as the BANKNET® virtual private network (VPN) of MasterCard International Incorporated of Purchase, N.Y., USA), a local area network (LAN), a wireless local area network (WLAN) (such as WiFi), Bluetooth, and/or wireless networks, such as a Long Term Evolution (LTE) network, WiMAX network, 3G network, etc.

The I/O device interfaces 602 may connect to a variety of components and networks. For example, the I/O device interfaces 602 may connect to the network interface 618, a video output 612, an audio output 614 and a camera 616. The device 110 may output video using the video output 612 and may output audio using the audio output 614. The device 110 may receive images or video as input from the camera 616. Among other things, the I/O device interfaces 602 may include an interface for an external peripheral device connection such as universal serial bus (USB), FireWire, Thunderbolt or other connection protocol.

As discussed above, device 110 and/or server 112 includes controller(s)/processors 604, memory 606, and storage 608. In addition, the device 110 and/or server 112 may include a dynamic price authorization module 640 and/or a dynamic price determination module 650, each of which may comprise processor-executable instructions stored in storage 608 to be executed by controller(s)/processor(s) 604 (e.g., software, firmware), hardware, or some combination thereof. For example, components of the dynamic price authorization module 640 and/or the dynamic price determination module 650 may be part of a software application running in the foreground and/or background on the device 110. Other configurations are also possible.

The dynamic price authorization module 640 may be configured to receive or access cardholder data associated with payment account data. For example. the dynamic price authorization module 640 may be configured to receive authorization from a user to use the cardholder data. The dynamic price authorization module 640 may transmit a request to the dynamic price determination module 650 to determine dynamic price(s) for selected movie(s). The dynamic price authorization module 640 may be configured to receive the dynamic price(s) for the selected movie(s) and may transmit the dynamic price(s) and selected movie(s) to a display. The dynamic price authorization module 640 may be configured to receive authorization from a user to accept the dynamic price being offered. Finally, the dynamic price authorization module 640 may enable streaming of the selected movie.

The dynamic price determination module 650 may be configured to access the payment account data provided by the payment account data warehouse 154, access the media purchase database 120 and obtain the media content item(s) associated with an account number, access public or private movie data and/or promotional data via network(s) 138. The dynamic price authorization module 640 may use the payment account data, the media content item(s), the movie data and/or the promotional data to calculate dynamic price(s) for media content item(s). For example, the dynamic price may be based on movie data (such as how long the movie has been released and/or an average ticket price), promotional data (such as promotions that lower the price to increase purchases), number of viewers and/or prior media purchase data from the payment account data (such as an average amount spent on movies and/or previous dynamic price history).

The dynamic price authorization module 640 and/or a dynamic price determination module 650 may be connected to the bus 624, input/output interfaces 602, controller/processor 604, and/or other component of the device 110 and/or server 112. For example, data sent to the dynamic price authorization module 640 and/or a dynamic price determination module 650 may come from the storage 608 or the input/output interfaces 602, such as data sent to the device 110 and/or server 112 over a network, as well as any other component located in the device 110.

In the examples illustrated in FIGS. 3, 4, 5A and 5B, above media content items are described as movies. However, these examples are provided for ease of explanation and the disclosure is not limited thereto. For example, the methods described in FIGS. 3, 4, 5A and 5B may apply to any media content item without departing from the present disclosure.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teaching of the present disclosure.

Although specific components have been set forth, it will be appreciated by those skilled in the art that not all of the disclosed components are required to practice the disclosed configurations. Moreover, certain well known components have not be described, to maintain focus of the disclosure.

The computer systems and servers described herein each contain a memory that will configure associated processors to implement methods, steps, and functions described. Such methods, steps, and functions can be carried out, e.g., by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more aspects of a system can include a computer program comprising computer program code adapted to perform one or more steps described when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Computers discussed herein can be interconnected, for example, by one or more of network, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like.

As described herein a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc., online communications, satellite communications, off-line communications, wireless communications, transponder communications, local area network (LAN), wide area network (WAN), virtual private network (VPN), networked or linked devices, keyboard, mouse, combinations thereof and/or any suitable communication or data input modality.

Various databases used herein may include: consumer data; creditor data; third party institution data; and/or like data useful in the operation of the system. As those skilled in the art will appreciate, the consumer may use a computer in the method described and the user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments may be referred to in terms, such as assessing, determining, matching or selecting, which are commonly associated with mental operations performed by a human operator. No such capability of a human operator is necessary, or desirable, in any of the operations described herein. Rather, the operations may be machine operations. After reading this description, it may become apparent to a person skilled in the relevant art(s) how to implement various embodiments using other computer systems and/or architectures.

Any such computer system also includes a main memory, such as for example random access memory (RAM), and may also include a secondary memory or a removable storage unit. Removable storage unit represents a floppy disk, magnetic tape, optical disk, etc. which is read by and written to by removable storage drive. As will be appreciated, the removable storage unit includes a computer usable storage medium having stored therein computer software and/or data.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, software may be implemented in hardware components such as application specific integrated circuits (ASICs). Implementation of a hardware state machine to perform the functions described herein will be apparent to persons skilled in the relevant art(s).

Databases or data warehouses discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art.

As will be appreciated by one of ordinary skill in the art, the system may be embodied as a customization of an existing system, an add-on product, a processing apparatus executing upgraded software, a stand-alone system, a distributed system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Any suitable computer-readable storage medium may be utilized, including hard disks, CD-ROM, optical storage devices, magnetic storage devices, and/or the like.

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiments may be include plural embodiments, and references to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, steps described and the descriptions thereof may comprise configurations of and make reference to user windows, pop-up windows, webpages, websites, web forms, prompts, or the like.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A computer implemented method of determining a dynamic price for a media content item, the method comprising the steps of:
acquiring cardholder data;
retrieving payment account data from an account database, the payment account data associated with the cardholder data and including one or more transactions associated with one or more account numbers within a period of time;
acquiring data associated with the media content item; and
determining a dynamic price for the media content item based on the payment account data, the data associated with the media content item and a number of viewers.

2. The method of claim 1, further comprising:
transmitting the dynamic price;
receiving authorization of the dynamic price; and
enabling streaming of the media content item.

3. The method of claim 2, wherein the determining the dynamic price further comprises:
determining a dynamic price for the media content item based on the payment account data, the data associated with the media content item, the number of viewers and a previous dynamic price acceptance history, wherein the previous dynamic price acceptance history is based on a number of previous authorizations for additional media content items associated with the payment account data.

4. The method of claim 1, further comprising:
accessing media purchase data associated with the cardholder data,
wherein the determining the dynamic price further comprises determining a dynamic price for the media content item based on the payment account data, the data associated with the media content item, the number of viewers and the media purchase data.

5. The method of claim 1, further comprising:
determining demographic information from the payment account data; and
determining average movie viewing expenses based on previous transactions included in the payment account data,
wherein the determining the dynamic price further comprises determining a dynamic price for the media content item based on the payment account data, the demographic information, the average movie viewing expenses, the data associated with the media content item and the number of viewers.

6. The method of claim 1, wherein the data associated with the media content item includes at least one of showtimes, a release data, box office sales, promotional data, cast, genre, and maturity rating.

7. The method of claim 1, further comprising:
determining the number of viewers based on one of the payment account data, demographics, receiving input providing the number of viewers.

8. A computer implemented method of authorizing a dynamic price for one or more media content items, the method comprising the steps of:
receiving payment device data associated with payment account data;
obtaining dynamic prices for one or more media content items based on the payment account data and the one or more media content items;
displaying the one or more media content items and corresponding dynamic prices;
receiving a request for a selected media content item, the request including authorization for the dynamic price associated with the selected media content item;
transmitting the authorization for the dynamic price associated with the selected media content item; and
enabling streaming of the selected movie.

9. A computer implemented method of authorizing a dynamic price for one or more media content items, the method comprising the steps of:
displaying the one or more media content items;
receiving a request for a selected media content item, the request including cardholder data associated with payment account data;
obtaining a dynamic price for the selected media content item based on the payment account data and the selected media content item;
displaying the dynamic price;
receiving authorization for the dynamic price; and
enabling streaming of the selected media content item.

10. A system comprising:
a memory;
at least one processor operatively coupled to the memory; and
a persistent storage device operatively coupled to the memory and storing in a non-transitory manner instructions that when loaded into the memory cause the at least one processor to be operative to:
acquire payment device data;
retrieve payment account data from an account database, the payment account data associated with the cardholder data and including one or more transactions associated with one or more account numbers within a period of time;
acquire data associated with the media content item; and
determine a dynamic price for the media content item based on the payment account data, the data associated with the media content item and a number of viewers.

11. The system of claim 10, wherein the instructions cause the at least one processor to:
transmit the dynamic price;
receive authorization of the dynamic price; and
enable streaming of the media content item.

12. The system of claim 11, wherein the instructions cause the at least one processor to:
determine a dynamic price for the media content item based on the payment account data, the data associated with the media content item, the number of viewers and a previous dynamic price acceptance history, wherein the previous dynamic price acceptance history is based on a number of previous authorizations for additional media content items associated with the payment account data.

13. The system of claim 10, wherein the instructions cause the at least one processor to:
access media purchase data associated with the cardholder data; and
determine a dynamic price for the media content item based on the payment account data, the data associated with the media content item, the number of viewers and the media purchase data.

14. The system of claim 10, wherein the instructions cause the at least one processor to:
determine demographic information from the payment account data;
determine average movie viewing expenses based on previous transactions included in the payment account data; and
determine a dynamic price for the media content item based on the payment account data, the demographic information, the average movie viewing expenses, the data associated with the media content item and the number of viewers.

15. The system of claim 10, wherein the data associated with the media content item includes at least one of showtimes, a release data, box office sales and promotional data.

16. The system of claim 10, wherein the instructions cause the at least one processor to:
determine the number of viewers based on one of the payment account data and receiving input providing the number of viewers.

17. A system comprising:
a memory;
at least one processor operatively coupled to the memory; and
a persistent storage device operatively coupled to the memory and storing in a non-transitory manner instructions that when loaded into the memory cause the at least one processor to be operative to:
receive payment device data associated with payment account data;
obtain dynamic prices for one or more media content items based on the payment account data and the one or more media content items;
display the one or more media content items and corresponding dynamic prices;
receive a request for a selected media content item, the request including authorization for the dynamic price associated with the selected media content item;
transmit the authorization for the dynamic price associated with the selected media content item; and
enable streaming of the selected movie.

18. A system comprising:
a memory;
at least one processor operatively coupled to the memory; and
a persistent storage device operatively coupled to the memory and storing in a non-transitory manner instructions that when loaded into the memory cause the at least one processor to be operative to:
display the one or more media content items;
receive a request for a selected media content item, the request including cardholder data associated with payment account data;
obtain a dynamic price for the selected media content item based on the payment account data and the selected media content item;
display the dynamic price;
receive authorization for the dynamic price; and
enable streaming of the selected media content item.
